(19) United States
(12) Patent Application Publication
(10) Pub. No.: US 2014/0119549 A1
(43) Pub. Date: May 1, 2014

(54) Monitoring microphone transmission quality by analyzing signals from an embedded sounder

(71) Applicant: Sander Jeroen van Wijngaarden, Den Haag (NL)

(72) Inventor: Sander Jeroen van Wijngaarden, Den Haag (NL)

(21) Appl. No.: 13/666,439

(22) Filed: Nov. 1, 2012

(51) Int. Cl. H04R 29/00

(52) U.S. Cl. CPC H04R 29/004
USPC 381/58

(57) ABSTRACT

A system and method is described for monitoring the recording quality of a microphone. Some microphones, mostly in fixed installations, already feature a (piezo) sounder built into the microphone housing which is used to assess whether the microphone is functioning properly. At random or fixed intervals, the sounder produces a known signal; the microphone signal is then measured to determine if the microphone is working The disclosed invention comes down to extension of this principle by not only testing if the signal is reproduced at the correct level, but also using the sounder to measure the transmission quality of the microphone. The sounder produces a signal designed for this purpose. Upon playback of this test signal, the microphone signal is analysed to determine the overall transmission quality of the microphone, and evaluate the influence of factors that degrade quality, such as noise, bandwidth limiting, dynamic range and reverberation.

### BACKGROUND

For some applications, microphones are installed permanently in order to monitor or record speech and other sounds. This is often done in a similar fashion as the way Closed Circuit TV cameras are used: multiples microphones, placed throughout a building, are recorded permanently and stored for a fixed and limited amount of time (e.g. 24 hours). During this time, the audio is kept, but nobody will listen to the recordings unless an incident has occurred. This type of microphone usage occurs as a means of theft prevention or as a general security measure in buildings, but also with Flight Data Recorders on aircraft and Voyage Data Recorders on ships. Some existing systems make use of (piezo) sounders, integrated with microphones or in the proximity of microphones, as a means of detecting whether the microphones are still functioning. The sound will sound (buzz or chime) at random or fixed intervals. If a microphone does not register the sound, then an automated warning is generated.

### SUMMARY

The disclosed invention is a system and apparatus for evaluation of the transmission quality of a microphone by generating a test signal through a sounder built into the microphone enclosure and analysing the signal recorded by the microphone. This progresses beyond the existing art since it is not only detected if the microphone is functioning, but the recording quality of the microphone is also evaluated.

The test signal consists of a carrier signal that is suitable for reproduction by the sounder, to which modulations have been applied. The modulation patterns are chosen in such a way that changes in the modulation pattern (such as decrease of the modulation depth) are indicative of degradation of the microphone signal. By analysing the modulation patterns after recording through the microphone, the overall transmission quality of the microphone can be assessed (e.g., on a scale of 0 to 1, or 0% to 100%). These and other features will be addressed in greater detail below.

### BRIEF DESCRIPTION OF THE DRAWING

FIG. 1 shows a 3D drawing of two examples of possible configurations of the microphone and sounder within the same enclosure. The left configuration shows how sounder (a) and microphone (b) are placed internally within the enclosure, opened acoustically to its surroundings by a single array of perforations. The right configuration shows how sounder (a) and microphone (b) each have their own array of perforations, but are still placed in the same enclosure.

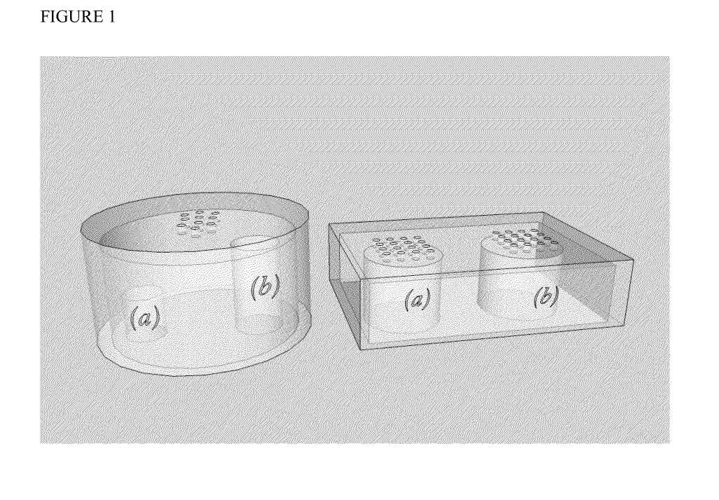

### DETAILED DESCRIPTION

The disclosed invention is a system and apparatus for evaluation of the transmission quality of a microphone by generating a test signal through a sounder built into the microphone enclosure and analysing the signal recorded by the microphone. This progresses beyond the existing art since it is not only detected if the microphone is functioning, but the recording quality of the microphone is also evaluated. To this end, a test signal that is designed for this purpose is played back by the sounder.

The test signal consists of a carrier signal that is suitable for reproduction by the sounder, to which modulations have been applied. These modulations can be frequency modulations or amplitude modulations. The modulation patterns are chosen in such a way, that changes in the modulation pattern (such as decrease of the modulation depth) are indicative of degradation of the microphone signal.

A decrease in modulation depth is interpreted as indicative of a decrease in signal quality. The degree to which the modulation depth is found to be decreased (compared to the original test signal played by the sounder) indicates the degree to which the signal is degraded, and is translated into a quality verdict on a scale of 0 to 1, or 0% to 100%. By analysing the degradation pattern, the cause of signal degradations can also be determined: interference by additive noise (such as electronic noise or ambient sounds) will affect modulations independently of the modulation frequency, whereas reverberation and other time-domain distortions become apparent as a modulation frequency-dependent decrease of modulation depth. If the test signal covers a sufficiently wide frequency band, which can be achieved by using noise, speech or sinusoidal complexes as a carrier signal, then the frequency transfer function of the microphone can also be evaluated.

The choice of carrier signal will depend on the type of sounder that is used. The carrier signal can be a noise signal, a speech fragment, a sinusoidal signal, or a complex of multiple sine waves. The choice depends on the capabilities and characteristics of the sounder.

What is claimed is:

1. A method of measuring the transmission quality of a microphone based on analysis of the recorded signal when playing a test signal through an embedded sounder, said sounder being built into the same housing as the microphone, said signal being specifically designed for the purpose of transmission quality evaluations on the recorded microphone signal

2. The method of claim 1, said test signal comprising a carrier signal which is modulated in frequency, modulated in amplitude or modulated in both amplitude and frequency.

3. The method of claim 2, said carrier signal consisting of noise, real speech, sinusoids or complexes of sinusoids.

4. The method of claim 1, said test signal being sufficiently low in sound pressure level to render the signal inaudible to human perception.

5. The method of claim 1, said transmission quality being expressed in an index on a scale of 0 to 1.

6. The method of claim 1, said transmission quality being expressed as a percentage on a scale of 0 to 100%.

7. An apparatus implementing the method of claims 1-6, comprising a microphone, a sounder built into the same housing as the microphone, a digital processor for analyzing the transmission quality of the microphone and software for analyzing the transmission quality of the microphone

8. The apparatus of claim 7, said processor being integrated into the microphone housing

9. The apparatus of claim 7, said processor being placed in a housing separate from the microphone and being connected though a digital network connection.
